(19) United States
(12) Patent Application Publication
(10) Pub. No.: US 2009/0009081 A1
(43) Pub. Date: Jan. 8, 2009

(54) Filter and plasma display panel having the same

(76) Inventor: Cha-Won Hwang, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/150,982

(22) Filed: May 2, 2008

(30) Foreign Application Priority Data
May 23, 2007 (KR) 10-2007-0050364

(51) Int. Cl. H01J 17/49

(52) U.S. Cl. 313/582

(57) ABSTRACT

The present embodiments relate to a plasma display panel (PDP) for preventing a glare effect caused by external light, and preventing a blur effect of an image. The PDP includes a first substrate, a second substrate facing the first substrate, a barrier rib, an address electrode, first and second electrodes, and a filter. The barrier rib is disposed between the first and second substrates and partitions discharge cells. The address electrode is disposed to correspond to the discharge cell and is extended in a first direction. The first and second electrodes are disposed by pairs to correspond to the discharge cell, and are extended in a second direction crossing the first direction. The filter is provided on the second substrate, and includes a bubble layer.

### CROSS-REFERENCE TO RELATED APPLICATION

This application claims priority to and the benefit of Korean Patent Application No. 10-2007-0050364 filed in the Korean Intellectual Property Office on May 23, 2007, the entire content of which is incorporated herein by reference.

### BACKGROUND OF THE INVENTION

1. Field of the Invention

The present embodiments relate to a filter and a plasma display panel (PDP) including the filter. More particularly, the present embodiments relate to a filter for preventing a blur of an image and a PDP including the filter.

2. Description of the Related Art

Generally, in a plasma display panel, plasma is generated by gas discharge, and phosphors are excited due to vacuum ultraviolet (VUV) rays generated during the plasma discharge. Then, the plasma display panel forms images by using the visible rays (red R, green G, and blue B) generated when the phosphor layers are stabilized.

A plasma display panel generally includes discharge cells between a front substrate and a rear substrate, and an image is realized by visible light transmitted from the discharge cell to the front substrate.

The front substrate transmits the visible light from the discharge cell to the outside, and reflects external light. In addition, the front substrate diffusely reflects the external light to prevent a glare effect.

The front substrate may include a filter on an outer surface. The filter can be formed by coating micro-particles on a base film. The micro-particles diffusely reflect the external light to prevent a glare effect.

However, the micro-particles coated to the base film are exposed to the air. Accordingly, a refractive index on an interface of the base film and the micro-particles is different from a refractive index on an interface of the micro-particles and the air. By the refractive index difference, an image of the visible light transmitted through the front substrate may be blurred.

The above information disclosed in this Background section is only for enhancement of understanding of the background of the present embodiments and therefore it may contain information that does not form the prior art that is already known to a person of ordinary skill in the art. The present embodiments overcome the problems described above as well as provide additional advantages.

### SUMMARY OF THE INVENTION

The present embodiments provide a filter for preventing a glare effect caused by an external light, and preventing a blur effect of an image and a plasma display panel (PDP) including the filter.

An exemplary PDP according to an embodiment includes a first substrate, a second substrate facing the first substrate, a barrier rib, an address electrode, first and second electrodes, and a filter. The barrier rib may be disposed between the first and second substrates and may partition discharge cells. The address electrode may be disposed to correspond to the discharge cell and may be extended in a first direction. The first and second electrodes may be disposed by pairs to correspond to the discharge cell, and may be extended in a second direction crossing the first direction. The filter may be provided on the second substrate, and may include a bubble layer.

The filter may include at least one of an electromagnetic wave shield layer, a near infrared ray blocking layer, a neon light blocking layer, and a color compensation layer. The bubble layer may be disposed to be farthest to an outer surface of the second substrate.

The bubble layer may include a plurality of bubbles and a base film including the plurality of bubbles. The bubbles may be formed in a ball shape. The bubble layer may be formed to correspond to at least a partial area of the second substrate.

The base film may include a first base film and a second base film. The first base film forms one surface of the bubble layer and is disposed on the second substrate, and the second base film forms another surface of the bubble layer and is disposed to an opposite side of the first base film to be attached on the first base film.

The bubbles may be formed in a hemispherical shape.

The bubbles may be convex toward an outer surface of the filter.

### BRIEF DESCRIPTION OF THE DRAWINGS

FIG. 1 is a perspective view of a plasma display panel (PDP) according to a first exemplary embodiment.

FIG. 2 is a cross-sectional view along a line II-II shown in FIG. 1.

FIG. 3 is a top plan view representing an arrangement of a barrier rib and electrodes.

FIG. 4 is an expanded cross-sectional view of a filter including a bubble layer, a color compensation layer, a neon light blocking layer, a near infrared ray blocking layer, and an electromagnetic wave shield layer.

FIG. 5 is a cross-sectional view representing a diffused reflection of external light and a refraction state of visible light on the bubble layer according to the first exemplary embodiment.

FIG. 6 is a cross-sectional view representing a diffused reflection of the external light and a refraction state of the visible light on the bubble layer according to a second exemplary embodiment.

### DETAILED DESCRIPTION OF THE EMBODIMENTS

The present embodiments will be described more fully hereinafter with reference to the accompanying drawings, in which exemplary embodiments are shown. As those skilled in the art would realize, the described embodiments may be modified in various different ways, all without departing from the spirit or scope of the present embodiments. Accordingly, the drawings and description are to be regarded as illustrative in nature and not restrictive. Like reference numerals designate like elements throughout the specification.

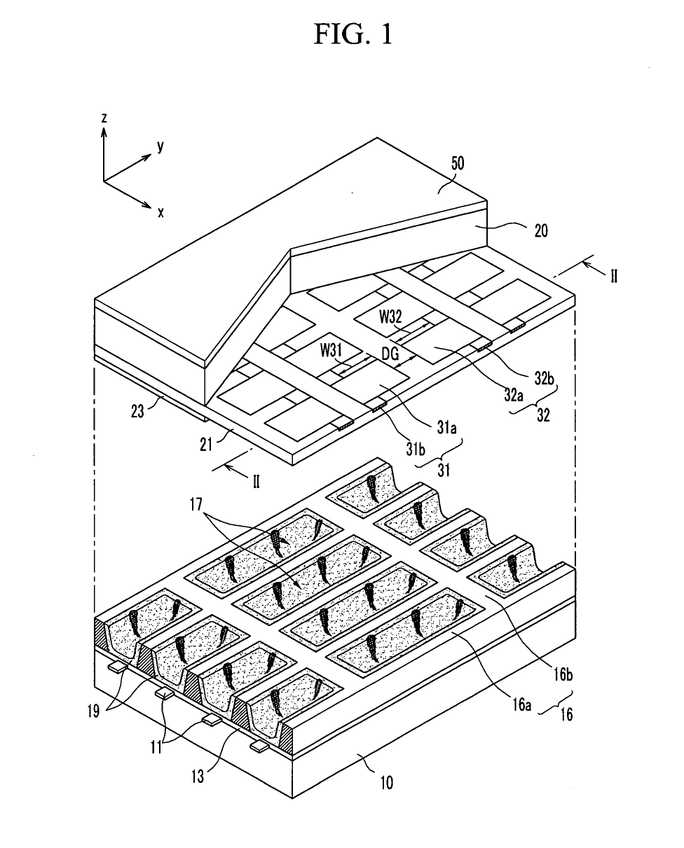

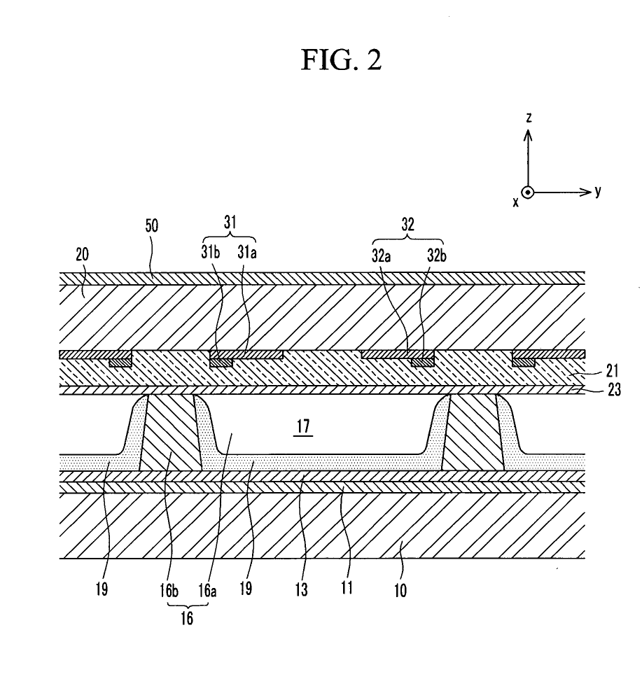

FIG. 1 is a perspective view of a plasma display panel (PDP) according to a first exemplary embodiment, and FIG. 2 is a cross-sectional view along a line II-II shown in FIG. 1.

Referring to FIG. 1 and FIG. 2, the PDP according to the first exemplary embodiment includes first and second substrates 10 and 20 (hereinafter, respectively referred to as rear and front substrates) that are disposed with a predetermined interval therebetween to face each other, and barrier ribs 16 provided between the two substrates 10 and 20.

The barrier ribs 16 are formed with a predetermined height between the rear and front substrates 10 and 20 to partition a plurality of discharge cells 17. The discharge cells 17 are charged with a discharge gas (e.g., a mixed gas including neon (Ne) and xenon (Xe)), and include phosphor layers 19.

The discharge gas generates vacuum ultraviolet (VUV) rays by the gas discharge, and the phosphor layer 19 is excited by the VUV rays and is stabilized to emit visible light.

A filter 50 is provided to the front substrate 20. The filter 50 is formed configured to transmit the visible light emitted from the discharge cell and prevent a glare effect caused by external light.

To generate the gas discharge in the discharge cell 17, an address electrode 11, a first electrode 31 (hereinafter, a “sustain electrode”), and a second electrode 32 (hereinafter, a “scan electrode”) are disposed between the rear and front substrates 10 and 20 while corresponding to the respective discharge cells 17.

For example, the address electrode 11 is extended on an inner surface of the rear substrate 10 along a first direction (i.e., a y-direction in the figures), and sequentially corresponds to the discharge cells that are adjacent in the y-axis direction.

In addition, the plurality of address electrodes 11 are disposed in parallel while corresponding to the discharge cells that are adjacent in a second direction (i.e., an x-axis direction in the figures) crossing the y-axis direction.

A first dielectric layer 13 covers the inner surface of the rear substrate 10 and the address electrodes 11. The first dielectric layer 13 prevents damage to the address electrodes 11, and forms and accumulates wall charges. The first dielectric layer 13 prevents the address electrode from being directly collided with by positive ions or electrons when a discharge is generated.

The address electrode 11 may be formed as an opaque electrode (e.g., a metal electrode such as silver (Ag) having excellent electrical conductivity). Since the address electrode 11 is disposed on the rear substrate 10, it does not prevent the visible light from being transmitted through the front substrate 20.

As an example, the barrier rib 16 can be provided on the first dielectric layer 13 of the rear substrate 10 to partition the discharge cells 17. In addition, the barrier rib 16 includes first barrier rib members 16a and second barrier rib members 16b that form the discharge cells 17 in a matrix format.

The first barrier rib members 16a are respectively extended in the y-axis direction, and are disposed in parallel in the x-axis direction with predetermined intervals therebetween. The second barrier rib members 16b are disposed between the first barrier rib members 16a in parallel in the Y direction with predetermined intervals therebetween, and are respectively extended in the x-axis direction.

In addition, the barrier rib 16 may be formed by the first barrier rib members extended in the y-axis direction without including the second barrier rib members. Accordingly, since the first barrier rib members are disposed in parallel in the x-axis direction, the discharge cells may be formed in a stripe pattern.

As an example, a phosphor paste can be coated on a side surface of the barrier rib 16 and a surface of the first dielectric layer surrounded by the barrier rib 16, and the coated phosphor paste is dried and baked to form the phosphor layers 19.

The phosphor layers 19 are formed to have the phosphor generating the same color visible light in the discharge cells 17 formed in the y-axis direction. In addition, the phosphor layers 19 are formed to have the phosphor generating red R, green G, and blue B visible light in the discharge cells 17 repeatedly disposed in the x-axis direction. The phosphor layers 19 formed to have the phosphor generating the red R, green G, and blue B light are repeatedly disposed in the x-axis direction.

The sustain electrode 31 and the scan electrode 32 are disposed on an inner surface of the front substrate 20 while corresponding to the discharge cells 17. The sustain electrode 31 and the scan electrode 32 form a surface discharge configuration to generate the gas discharge in the respective cells 17.

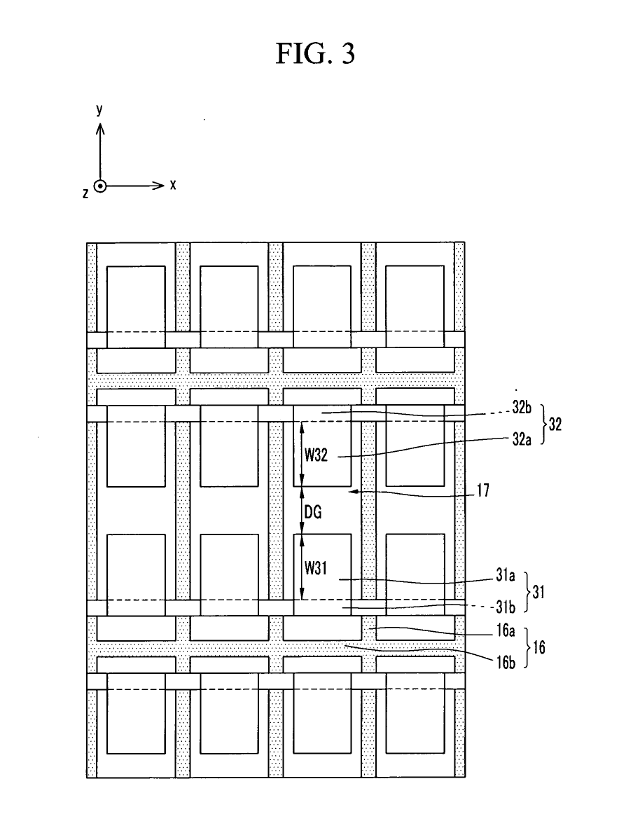

FIG. 3 is a top plan view representing an arrangement of the barrier rib 16 and the electrodes.

Referring to FIG. 3, the sustain electrode 31 and the scan electrode 32 are extended in the x-axis direction crossing the address electrode 11. The sustain electrode 31 and the scan electrode 32 respectively include transparent electrodes 31a and 32a generating discharges, and bus electrodes 31b and 32b respectively applying voltage signals to the transparent electrodes 31a and 32a.

Since the transparent electrodes 31a and 32a are disposed inside the discharge cell 17, they are formed of a transparent material (e.g., indium tin oxide (ITO)) to obtain an aperture ratio of the discharge cell 17. The bus electrodes 31b and 32b are formed of a metallic material having excellent electrical conductivity so as to apply the voltage signals to the transparent electrodes 31a and 32a.

The transparent electrodes 31a and 32a protrude from the contour of the discharge cell 17 to the center in the y-axis direction to be disposed in a center part of the discharge cell 17. That is, the transparent electrodes 31a and 32a are formed with respective widths W31 and W32 to form a discharge gap DG.

The bus electrodes 31b and 32b are extended in the x-axis direction on the contour of the discharge cell 17 to be respectively disposed on the transparent electrodes 31a and 32a. Accordingly, the voltage signals applied to the bus electrodes 31b and 32b are respectively applied to the transparent electrodes 31a and 32a that are respectively connected to the bus electrodes 31b and 32b and respectively correspond to the discharge cells 17.

Referring to FIG. 1 and FIG. 2, a second dielectric layer 21 covers the inner surface of the front substrate 20, the sustain electrode 31, and the scan electrode 32. The second dielectric layer 21 protects the sustain electrode 31 and the scan electrode 32 from the gas discharge, and forms and accumulates wall charges when a discharge is generated.

A protective layer 23 covers the second dielectric layer 21. For example, the protective layer 23 is formed of transparent MgO through which visible light is transmitted, covering the second dielectric layer 21, and it increases a secondary electron emission coefficient when a discharge is generated.

When the rear substrate 10 and the front substrate 20 are combined, the barrier rib 16 on the rear substrate 10 and the protective layer 23 on the front substrate 20 touch each other. The discharge gas is charged through a small path (not shown) formed between the barrier rib 16 and the protective layer 23 after the gas in the discharge cell 17 is output through the small path (not shown).

The PDP performs an address discharge by the address electrode 11 and the scan electrode 32 to select turn-on discharge cells 17, performs a sustain discharge by the sustain electrode 31 and the scan electrode 32 disposed in the selected discharge cells 17 to drive the selected discharge cells 17, and realizes an image.

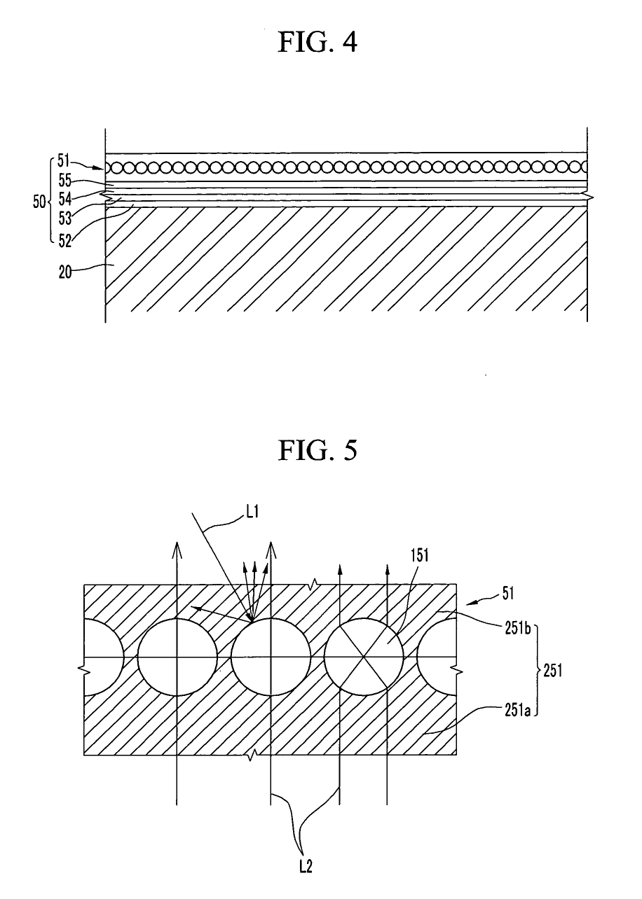

FIG. 4 is an expanded cross-sectional view of the filter including a bubble layer, a color compensation layer, a neon light blocking layer, a near infrared ray blocking layer, and an electromagnetic wave shield layer.

Referring to FIG. 4, the filter 50 diffusedly reflects the external light to prevent the glare effect; it is formed to not interrupt the visible light transmission, and it is mounted on the front substrate 20.

The filter 50 includes a bubble layer 51. The bubble layer 51 diffusedly reflects the external light, and includes the same medium as the air outside the filter 50 so that the visible light transmitted from the discharge cell 17 to the air through the front substrate 20 may not be interrupted.

The filter 50 includes an electromagnetic wave shield layer 52, a near infrared ray blocking layer 53, a neon light blocking layer 54, and a color compensation layer 55 that are accumulated on the front substrate 20.

The filter 50 may include all of the electromagnetic wave shield layer 52, the near infrared ray blocking layer 53, the neon light blocking layer 54, and the color compensation layer 55, and it may include one or more than one of the layers according to image realizing performance of the PDP. In addition, one type of layer may be accumulated to form the filter.

The electromagnetic wave shield layer 52 shields electromagnetic waves emitted toward the front substrate 20, and it may be formed by one or more electromagnetic wave shield layers 52 according to generation of the electromagnetic waves. The near infrared ray blocking layer 53 absorbs near infrared rays emitted toward the front substrate 20, and it may be formed by one or more near infrared ray blocking layers 53.

The neon light blocking layer 54 absorbs peak neon light of a predetermined wavelength range, and the color compensation layer 55 compensates an image projected through the front substrate 20 based on reference colors.

For example, the bubble layer 51 is disposed on an area that is farthest to an external surface of the front substrate 20 among the layers of the filter 50. Once the external light is projected to the filter 50, the bubble layer 51 diffusedly reflects the external light. Accordingly, the glare effect in front of the filter 50 may be prevented.

FIG. 5 is a cross-sectional view representing a diffused reflection of the external light and a refraction state of the visible light on the bubble layer according to the first exemplary embodiment.

Referring to FIG. 5, the bubble layer 51 includes a plurality of bubbles 151, and a base film 251 including the bubbles 151. The bubbles 151 may be formed in a ball shape for example.

The ball-shaped bubbles 151 diffusedly reflect the external light L1 from an interface of the bubbles 151 and the base film 251 to prevent the glare effect.

In addition, the ball-shaped bubbles 151 do not interrupt front-projection of the visible light L2 transmitted through the front substrate 20. That is, the visible light L2 is firstly refracted from the interface of the base film 251 and the bubbles 151, and is secondly refracted from the interface of the bubbles 151 and the base film 251.

Since a first refractive index and a secondary refractive index have a reciprocal relationship, the visible light L2 has a path on the same straight line when it is transmitted through the front substrate 20 to be input to the filter 50 and to be output to the air.

Here, the bubbles 151 are formed on the base film 251 neighboring the air, and in this case, the refraction of the visible light L2 on the interface of the base film 251 and the air may be ignored.

The bubbles 51 diffusedly reflect the external light L1 to prevent the glare effect caused by the external light L1, and maintain a path of the visible light L2 projected to the air through the front substrate 20 in the discharge cell 17. Accordingly, the blur of the image may be prevented.

The bubble layer 51 may be formed on at least a partial area of the entire front substrate 20.

For example, the base film 251 is formed by one film and includes the bubbles 151 therein to form the bubble layer 51. In the bubble layer 51, since the base film 251 is manufactured in an effervescent configuration, the bubbles 151 may be formed in the base film 251.

In another example, the base film 251 may be formed by combining a first base film 251a and a second base film 251b. The first base film 251a and the second base film 251b having protrusions and depressions are combined to form the bubbles 151.

The first base film 251a is disposed on the front substrate 20 to form a part of the bubble layer 51, and the second base film 251b forms another part of the bubble layer 51. The second base film 251b is disposed in a remote area from the front substrate 20.

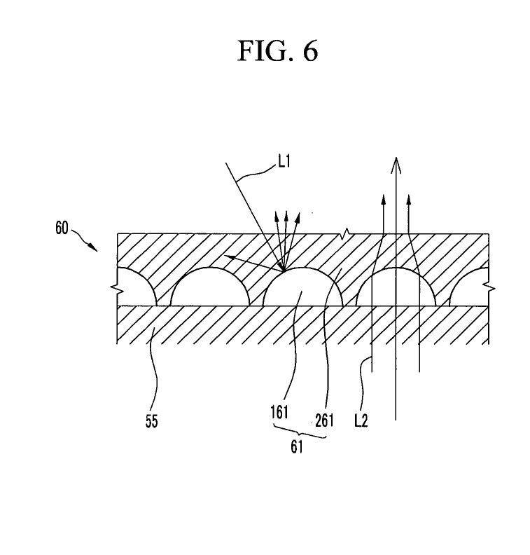

FIG. 6 is a cross-sectional view representing a diffused reflection of the external light and a refraction state of the visible light on the bubble layer according to a second exemplary embodiment.

The second exemplary embodiment will now be described with reference to FIG. 6. In the second exemplary embodiment, descriptions of parts having been described in the first exemplary embodiment will be omitted.

A bubble layer 61 of the filter 60 includes bubbles 161 and a base film 261. The bubbles 161 may be formed in a hemispherical shape.

Differing from the first exemplary embodiment, the base film 261 is formed by one film, and the bubbles 161 are convex toward the outer surface of the filter 60. While a layer immediately below the base film 261 may be the color compensation layer 55 of the filter 60, is the present embodiments are not limited thereto.

One surface of the base film 261 has protrusions and depressions, and the bubbles 161 are formed between the color compensation layer 55 and the base film 261 when the color compensation layer 55 is attached to the surface having protrusions and depressions.

The hemispherical-shaped bubbles 161 do not interrupt the front-projection of the visible light L2 transmitted through the front substrate 20. That is, the visible light L2 is refracted on the interface of the bubbles 161 and the base film 261.

In this case, the bubbles 161 are formed on the base film 251 neighboring the air. The refraction of the visible light L2 on the interface of the base film 261 and the air may be ignored. Accordingly, the visible light L2 projected to the air forms a concentrated path compared to when the visible light L2 is transmitted to the bubble layer 61 through the front substrate 20.

The bubble layer 61 having the hemispherical-shaped bubbles 161 diffusedly reflects the external light L1 to prevent the glare effect, and prevents the blur of the image.

While these embodiments have been described in connection with what is presently considered to be practical exemplary embodiments, it is to be understood that the present embodiments are not limited to the disclosed embodiments, but, on the contrary, is intended to cover various modifications and equivalent arrangements included within the spirit and scope of the appended claims.

As described above, in the PDP according to the exemplary embodiment, the filter having the bubble layer is formed on the front substrate. The bubble layer transmits the visible light therethrough, and diffusedly reflects the external light. Accordingly, the glare effect may be prevented.

In addition, the bubbles of the bubble layer include the same medium as the air. When the mediums are different, the refractive indexes are different, and the visible light may be refracted. The reflection of the visible light causes the blur effect of the image. The filter according to the exemplary embodiment and the PDP including the filter may prevent the blur effect of the image.

What is claimed is:

1. A plasma display panel (PDP) comprising:
a first substrate;
a second substrate facing the first substrate;
a barrier rib that is disposed between the first and second substrates and partitions discharge cells;
an address electrode that is disposed to correspond to the discharge cell and is extended in a first direction;
first and second electrodes that are disposed by pairs to correspond to the discharge cell, and are extended in a second direction crossing the first direction; and
a filter provided on the second substrate which includes a bubble layer.

2. The PDP of claim 1, wherein the filter further comprises at least one of an electromagnetic wave shield layer, a near infrared ray blocking layer, a neon light blocking layer, and a color compensation layer.

3. The PDP of claim 2, wherein the bubble layer is disposed to be farthest to the outer surface of the second substrate.

4. The PDP of claim 1, wherein the bubble layer comprises a plurality of bubbles and a base film including the plurality of bubbles.

5. The PDP of claim 4, wherein the bubbles have a ball shape.

6. The PDP of claim 5, wherein the bubble layer is formed to correspond to at least a partial area of the second substrate.

7. The PDP of claim 4, wherein the base film comprises:
a first base film that forms one surface of the bubble layer and is disposed on the second substrate; and
a second base film that forms another surface of the bubble layer and is disposed to an opposite side of the first base film configured to be attached on the first base film.

8. The PDP of claim 4, wherein the bubbles have a hemispherical shape.

9. The PDP of claim 8, wherein the bubbles are convex toward the outer surface of the second substrate.

10. A filter mounted on a front substrate of a plasma display panel configured to transmit visible light, wherein the filter comprises a bubble layer.

11. The filter of claim 10, further comprising at least one of an electromagnetic wave shield layer, a near infrared ray blocking layer, a neon light blocking layer, and a color compensation layer.

12. The filter of claim 11, wherein the bubble layer is disposed to be farthest to the external surface of the front substrate.

13. The filter of claim 10, wherein the bubble layer comprises:
a plurality of bubbles; and
a base film comprising the plurality of bubbles.

14. The filter of claim 13, wherein the bubbles have a ball shape.

15. The filter of claim 14, wherein the bubble layer is formed on at least a partial area of the front substrate.

16. The filter of claim 13, wherein the base film comprises:
a first base film that forms one surface of the bubble layer, and is disposed on the front substrate; and
a second base film that forms another surface of the bubble layer, and is disposed on an opposite side of the first base film configured to be attached on the first base film.

17. The filter of claim 13, wherein the bubbles have a hemisphere shape.

18. The filter of claim 17, wherein the bubbles are convex toward the outer surface of the filter.
